(19) United States
(12) Patent Application Publication
(10) Pub. No.: US 2026/0054423 A1
(43) Pub. Date: Feb. 26, 2026

(54) REUSE METHOD OF USED PET FILM, PELLET, AND RESIN MOLDED ARTICLE

(71) Applicant: KYOCERA Document Solutions Inc., Osaka (JP)

(72) Inventors: Koichiro TSUJIMOTO, Osaka (JP); Rina UENISHI, Osaka (JP); Teruo MORI, Osaka (JP); Tomochika OKUYAMA, Osaka (JP); Yosuke OKUNO, Osaka (JP)

(73) Assignee: KYOCERA Document Solutions Inc., Osaka (JP)

(21) Appl. No.: 19/308,371

(22) Filed: Aug. 25, 2025

(30) Foreign Application Priority Data
Aug. 26, 2024 (JP) 2024-144552

(51) Int. Cl. B29B 17/04; B29B 17/02; B29C 49/00; B29C 49/06; B29K 67/00; B29K 83/00; B29L 31/00; B29L 31/34

(52) U.S. Cl. CPC B29B 17/0412; B29B 17/02; B29C 49/0005; B29C 49/06; B29B 2017/0217; B29K 2067/003; B29K 2083/00; B29L 2031/3406; B29L 2031/7678

(57) ABSTRACT

A reuse method of a used PET film includes a removal process including mechanically removing, from the used PET film, the ceramic stuck to the surface of the used PET film, a flaking process including processing the used PET film, from which the ceramic stuck to the surface has been removed, into a flake, a first pelletizing process including processing the flake into a first pellet, an adding process including adding an anti-crystallization agent to the first pellet, a second pelletizing process including processing the first pellet, to which the anti-crystallization agent has been added, into a second pellet, and a molding process including forming a resin molded article through an injection blow molding process, from the second pellet.

### INCORPORATION BY REFERENCE

This application claims priority to Japanese Patent Application No. 2024-144552 filed on Aug. 26, 2024, the entire contents of which are incorporated by reference herein.

### BACKGROUND

The present disclosure relates to a reuse method of a used PET film, a pellet, and a resin molded article, and in particular to the reuse method of the used PET film having a ceramic stuck to the surface thereof, the pellet, and the resin molded article.

As part of environmental resources management, reuse of materials has come to be promoted. For example, a PET film is used as a carrier film in an intermediate process in the manufacturing of layered electronic parts, such as a multilayer ceramic capacitor, and the reuse of the used PET film is also being promoted. Examples of a reuse method of the used PET film include removing foreign substances stuck to the surface of the PET film with a cleaning liquid containing an organic solvent, and removing the cleaning liquid remaining on the surface of the PET film, thereby recycling the used PET film as a renewed PET film.

### SUMMARY

The disclosure proposes further improvement of the foregoing technique.

In an aspect, the disclosure provides a reuse method of a used PET film, with a ceramic stuck to a surface thereof. The reuse method of the used PET film includes a removal process, a flaking process, a first pelletizing process, an adding process, a second pelletizing process, and a molding process. The removal process includes mechanically removing, from the used PET film, the ceramic stuck to the surface of the used PET film. The flaking process includes processing the used PET film, from which the ceramic stuck to the surface has been removed in the removal process, into a flake. The first pelletizing process includes processing the flake produced in the flaking process into a first pellet. The adding process includes adding an anti-crystallization agent to the first pellet, produced in the first pelletizing process. The second pelletizing process includes processing the first pellet, to which the anti-crystallization agent has been added in the adding process, into a second pellet. The molding process includes forming a resin molded article through an injection blow molding process, from the second pellet produced in the second pelletizing process.

In another aspect, the disclosure provides a pellet produced from a used PET film with a ceramic stuck to a surface thereof, through a process including mechanically removing, from the used PET film, the ceramic stuck to the surface of the used PET film, processing the used PET film, from which the ceramic stuck to the surface has been removed, into a flake, processing the flake into a first pellet, adding an anti-crystallization agent to the first pellet, and producing the pellet by processing the first pellet to which the anti-crystallization agent has been added.

In still another aspect, the disclosure provides a resin molded article, formed from the mentioned pellet through an injection blow molding process.

In still another aspect, the disclosure provides a reuse method of a used PET film, with a ceramic stuck to a surface thereof. The reuse method of the used PET film includes a removal process, a flaking process, an adding process, a pelletizing process, and a molding process. The removal process includes mechanically removing, from the used PET film, the ceramic stuck to the surface of the used PET film. The flaking process includes processing the used PET film, from which the ceramic stuck to the surface has been removed in the removal process, into a flake. The adding process includes adding an anti-crystallization agent to the flake produced in the flaking process. The pelletizing process includes processing the flake, to which the anti-crystallization agent has been added in the adding process, into a pellet. The molding process includes forming a resin molded article, through an injection blow molding process, from the pellet produced in the pelletizing process.

In still another aspect, the disclosure provides a pellet produced from a used PET film with a ceramic stuck to a surface thereof, through a process including mechanically removing, from the used PET film, the ceramic stuck to the surface of the used PET film, processing the used PET film, from which the ceramic stuck to the surface has been removed, into a flake, adding an anti-crystallization agent to the flake, and processing the flake to which the anti-crystallization agent has been added, into the pellet.

### BRIEF DESCRIPTION OF THE DRAWINGS

FIG. 1A is a perspective view showing a stage of a manufacturing process of a multilayer ceramic capacitor, for explaining how a ceramic is stuck to the surface of a PET film, to be used for the reuse method of the used PET film according to a first embodiment of the disclosure;

FIG. 1B is a perspective view showing another stage of the manufacturing process of the multilayer ceramic capacitor;

FIG. 1C is a perspective view showing another stage of the manufacturing process of the multilayer ceramic capacitor;

FIG. 1D is a perspective view showing another stage of the manufacturing process of the multilayer ceramic capacitor;

FIG. 2 is a flowchart showing steps of the reuse method of the used PET film according to the first embodiment;

FIG. 3A is a schematic perspective view showing an article involved in the reuse method of the used PET film specified in FIG. 2;

FIG. 3B is a schematic perspective view showing another article involved in the reuse method of the used PET film specified in FIG. 2;

FIG. 3C is a schematic drawing showing other articles involved in the reuse method of the used PET film specified in FIG. 2;

FIG. 3D is a schematic drawing showing other articles involved in the reuse method of the used PET film specified in FIG. 2;

FIG. 3E is a schematic drawing showing other articles involved in the reuse method of the used PET film specified in FIG. 2;

FIG. 3F is a schematic drawing showing other articles involved in the reuse method of the used PET film specified in FIG. 2;

FIG. 3G is a schematic perspective view showing another article involved in the reuse method of the used PET film specified in FIG. 2;

FIG. 4 is a schematic drawing for explaining a mechanism for removing the ceramic stuck to the surface of the used PET film, in the ceramic removal process included in FIG. 2;

FIG. 5A is a graph showing measurement results provided by a differential scanning calorimeter, when an anti-crystallization agent is not added;

FIG. 5B is a graph showing measurement results provided by the differential scanning calorimeter, when an anti-crystallization agent is added;

FIG. 6 is a flowchart showing steps of the reuse method of the used PET film according to a second embodiment;

FIG. 7A is a schematic perspective view showing an article involved in the reuse method of the used PET film specified in FIG. 6;

FIG. 7B is a schematic perspective view showing another article involved in the reuse method of the used PET film specified in FIG. 6;

FIG. 7C is a schematic drawing showing other articles involved in the reuse method of the used PET film specified in FIG. 6;

FIG. 7D is a schematic drawing showing other articles involved in the reuse method of the used PET film specified in FIG. 6;

FIG. 7E is a schematic drawing showing other articles involved in the reuse method of the used PET film specified in FIG. 6; and

FIG. 7F is a schematic perspective view showing another article involved in the reuse method of the used PET film specified in FIG. 6.

### DETAILED DESCRIPTION

Hereafter, a reuse method of a used PET film, according to some embodiments of the disclosure, will be described with reference to the drawings.

### First Embodiment

The reuse method of the used PET film according to a first embodiment of the disclosure will be described hereunder, with reference to the drawings.

To start with, a used PET film with a ceramic stuck to the surface thereof will be described.

The PET film is used, for example, in an intermediate process of manufacturing of layered electronic parts, such as a multilayer ceramic capacitor. When the PET film is used in the intermediate process of the manufacturing of the layered electronic parts, a ceramic is stuck to the surface of the PET film. The used PET film, having the residual ceramic stuck to the surface thereof, after the layered electronic parts is separated from the PET film in the intermediate process, is to be reused.

The PET film has, for example, an elongate shape, and contains at least polyethylene terephthalate (PET) and a silicone resin. The content rate of the PET is, for example, 98%, and the content rate of the silicone resin is 2% or less. The used PET film refers to such PET film that has been used for the manufacturing of the layered electronic parts, and the residual ceramic is stuck to the surface of the used PET film.

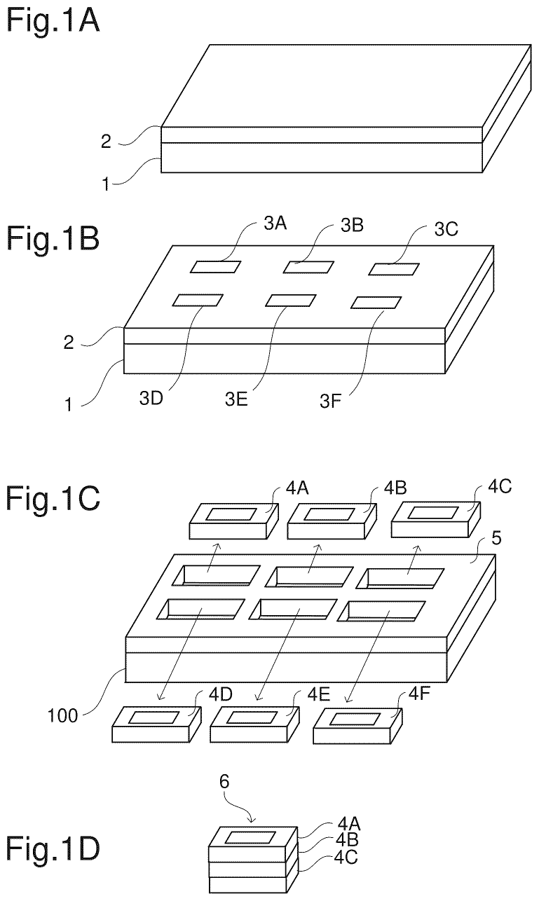

Referring to FIG. 1A to FIG. 1D, how the ceramic is stuck to the surface of the PET film will be described hereunder. FIG. 1A is a perspective view showing a stage of the manufacturing process of the multilayer ceramic capacitor, for explaining how the ceramic is stuck to the surface of the PET film, to be used for the reuse method of the used PET film. FIG. 1B is a perspective view showing another stage of the manufacturing process of the multilayer ceramic capacitor. FIG. 1C is a perspective view showing another stage of the manufacturing process of the multilayer ceramic capacitor. FIG. 1D is a perspective view showing another stage of the manufacturing process of the multilayer ceramic capacitor.

The PET film 1 has, for example, an elongate shape, and contains at least PET and a silicone resin. The PET film 1 includes a base film, and a release layer formed on one side of the base film. The base film contains the PET, and the release layer contains the silicone resin. Because of containing the silicone resin, the release layer obtains high releasability, and contributes to reducing the amount of the residual ceramic, remaining on the surface of the release layer, after a ceramic green sheet, to be subsequently described, is removed.

Referring to FIG. 1A, a slurry containing derivative ceramic powder, a binder, and an organic solvent is applied in a sheet shape to the surface of the release layer constituting a part of the PET film 1, for example by a doctor blade method, and the organic solvent component is removed by drying, so that a ceramic green sheet 2 is formed. The binder may include, for example, a polyvinyl butyral (PVB) resin. Examples of the material of the organic solvent include ethanol, and toluene.

Then an electrode paste, containing for example nickel, is screen-printed on the surface of the ceramic green sheet 2, so that electrode patterns 3A to 3F are formed, as shown in FIG. 1B. In FIG. 1B to FIG. 1D, the electrode patterns 3A to 3F are indicated by rectangles (a), for the sake of simplicity of the drawings.

The ceramic green sheet 2 having the electrode patterns 3A to 3F formed thereon is cut in a rectangular shape, and the rectangular portions formed by cutting are separated from the PET film 1, so that the parts 4A to 4F of the multilayer ceramic capacitor, each corresponding to one layer, are formed, as shown in FIG. 1C. When the rectangular portions formed by cutting are separated from the PET film 1, a remainder 5 of the ceramic green sheet 2 remains on the used PET film 100, as shown in FIG. 1C. Thus, the used PET film 100 with the ceramic stuck to the surface thereof is formed.

Then a predetermined number of parts of the multilayer ceramic capacitor, each corresponding to one layer, are stacked. For example, as shown in FIG. 1D, three parts 4A to 4C of the multilayer ceramic capacitor, each corresponding to one layer, are stacked, and an electrode pattern is formed on the outer surface of the layered body stacked as above, so that a multilayer ceramic capacitor 6 is obtained.

The mentioned formation process of the used PET film with the ceramic stuck to the surface thereof is merely exemplary, and the used PET film with the ceramic stuck to the surface thereof is to be reused in the first embodiment, irrespective of how the ceramic has been stuck to the surface of the used PET film.

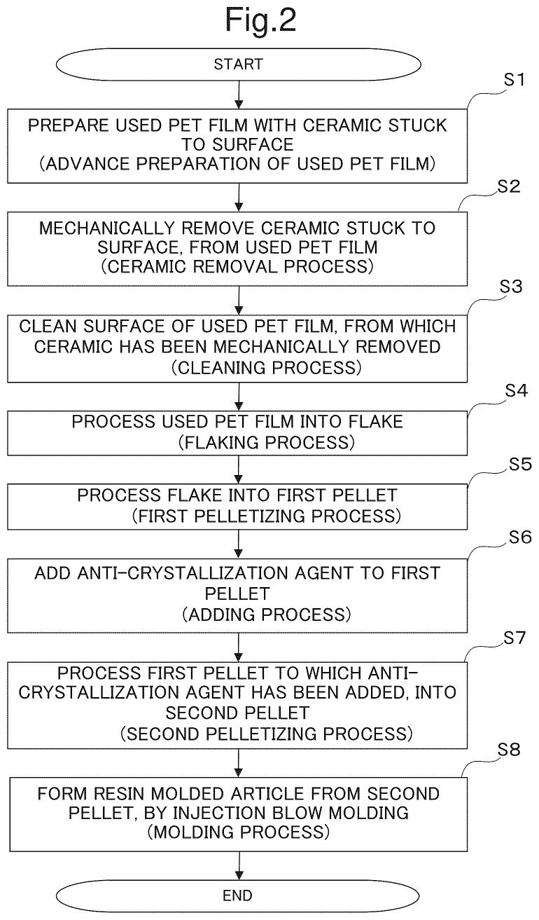

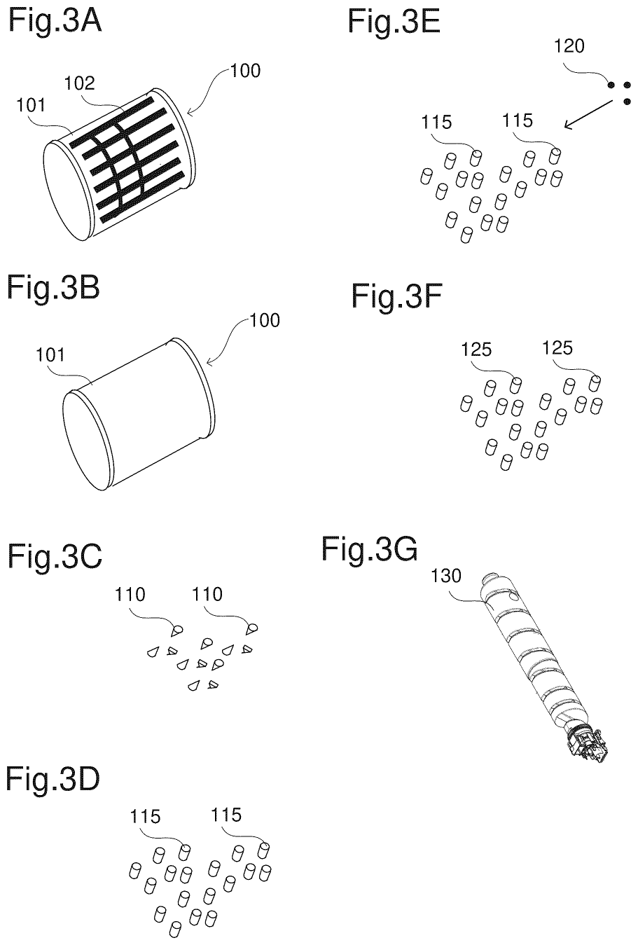

Hereunder, the steps of the reuse method of the used PET film with the ceramic stuck to the surface thereof will be described, with reference to FIG. 2, and FIG. 3A to FIG. 3D. FIG. 2 is a flowchart showing the steps of the reuse method of the used PET film according to the first embodiment. FIG. 3A is a schematic perspective view showing an article involved in the reuse method of the used PET film specified in FIG. 2. FIG. 3B is a schematic perspective view showing another article involved in the reuse method of the used PET film specified in FIG. 2. FIG. 3C is a schematic drawing showing other articles involved in the reuse method of the used PET film specified in FIG. 2. FIG. 3D is a schematic drawing showing other articles involved in the reuse method of the used PET film specified in FIG. 2. FIG. 3E is a schematic drawing showing other articles involved in the reuse method of the used PET film specified in FIG. 2. FIG. 3F is a schematic drawing showing other articles involved in the reuse method of the used PET film specified in FIG. 2. FIG. 3G is a schematic perspective view showing another article involved in the reuse method of the used PET film specified in FIG. 2.

First, the used PET film with the ceramic stuck to the surface thereof is prepared (step S1: advance preparation of used PET film). The used PET film at least contains the PET and the silicone resin. On the used PET film 100, prepared in the advance preparation of the used PET film of step S1, a ceramic 102 is stuck to a surface 101, as shown in FIG. 3A. Here, FIG. 3A illustrates the used PET film 100 wound in a roll shape.

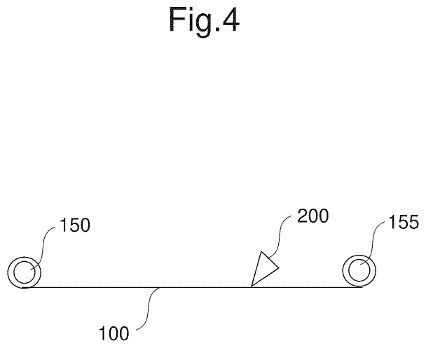

The ceramic stuck to the surface of the used PET film is mechanically removed, from the used PET film (step S2: ceramic removal process). In the ceramic removal process of step S2, for example, the used PET film 100 is drawn out with rollers 150, 155, and then wound again with the rollers 150, 155 with a blade 200 brought into contact with the surface 101 of the used PET film 100, to which the ceramic 102 is stuck, as shown in FIG. 4. Accordingly, the blade 200, in contact with the ceramic 102 stuck to the surface 101 of the used PET film 100, scrapes off the ceramic 102 from the surface 101 of the used PET film 100, while the used PET film 100 is being rolled up. Here, to mechanically remove the ceramic in the ceramic removal process (step S2), a known method may be adopted. Through the ceramic removal process of step S2, the used PET film 100 with the ceramic 102 stuck to the surface 101, shown in FIG. 3A, is transformed to the used PET film 100 from which the ceramic 102 stuck to the surface 101 has been removed, as shown in FIG. 3B.

In the ceramic removal process (step S2), the ceramic 102 stuck to the surface 101 is mechanically removed, leaving the silicone resin contained in the used PET film 100 unremoved. In other words, in the ceramic removal process (step S2), the silicone resin is left unremoved, when the ceramic stuck to the surface is mechanically removed.

The surface 101 of the used PET film 100, from which the ceramic has been mechanically removed in the ceramic removal process (step S2), is cleaned (step S3: cleaning process). In this process, for example, an organic solvent is employed.

The used PET film 100, from which the ceramic 102 stuck to the surface 101 has been removed in the ceramic removal process (step S2), and the surface of which has been cleaned in the cleaning process (step S3) according to the first embodiment, is processed into a flake (step S4: flaking process). In the flaking process (step S4), for example, the used PET film 100 may be crushed by a known grinder (having a known structure and a known function), into a size that a known extruder (having a known structure and a known function) can accept. Through the flaking process of step S4, the flake 110 shown in FIG. 3C is produced.

The flake produced in the flaking process (step S4) is processed into a first pellet (step S5: first pelletizing process). In the first pelletizing process (step S5), for example, the flake produced in the flaking process (step S4) may be loaded in the known extruder to be thermally fused, so that the first pellet of a processible size is produced. Through the first pelletizing process of step S5, the first pellet 115 shown in FIG. 3D is produced.

An anti-crystallization agent is added to the first pellet, produced through the first pelletizing process (step S5) (step S6: adding process). In the adding process of step S6, the operator adds the anti-crystallization agent 120 to the first pellet 115 as shown in FIG. 3E, and mixes them such that the first pellet 115 and the anti-crystallization agent 120 are evenly dispersed.

The first pellet, to which the anti-crystallization agent has been added in the adding process (step S6) is processed into a second pellet (step S7: second pelletizing process). In the second pelletizing process (step S7), a known method may be employed, such as the method described with reference to the first pelletizing process (step S5). step S7 Through the second pelletizing process of step S7, the second pellet 125 shown in FIG. 3F is produced.

A resin molded article is formed by injection blow molding, from the second pellet produced through the second pelletizing process (step S7) (step S8: molding process). The injection blow molding process includes, for example, loading a heated and fused resin by injection, in a mold under high temperature and high pressure, and then cooling and solidifying the resin, thereby forming a preform (injection molding), and holding the heated and fused preform with the mold, blowing compressed air into the fused preform, thereby expanding the preform so as to stick to the inner wall of the mold, and then cooling and solidifying the preform (blow molding, also referred to as hollow molding), thereby forming the resin molded article. Thus, the injection blow molding includes two types of molding methods, namely the injection molding and the blow molding. Examples of the resin molded article formed by injection blow molding include a toner container bottle 130 of the image forming apparatus, having the appearance shown in FIG. 3G.

In the ceramic removal process (step S2), as described above, the ceramic stuck to the surface of the used PET film is mechanically removed, leaving the silicone resin contained in the used PET film unremoved. Accordingly, the resin molded article contains the silicone resin. Therefore, the resin molded article formed through the molding process (step S8) can be, for example, appropriately used as sliding parts, which may be the sliding parts of the image forming apparatus, or sliding parts of a product other than the image forming apparatus. Examples of the sliding parts of the image forming apparatus include the toner container bottle 130, which is required to have slidability, and includes gears that are required to be slidable.

Here, the resin molded article formed in the molding process (step S8) may be, for example, the sliding parts of the image forming apparatus, the sliding parts of a product other than the image forming apparatus, parts of the image forming apparatus other than the sliding parts, parts other than the sliding parts, of a product other than the image forming apparatus, a product required to have slidability, or a product not required to have slidability.

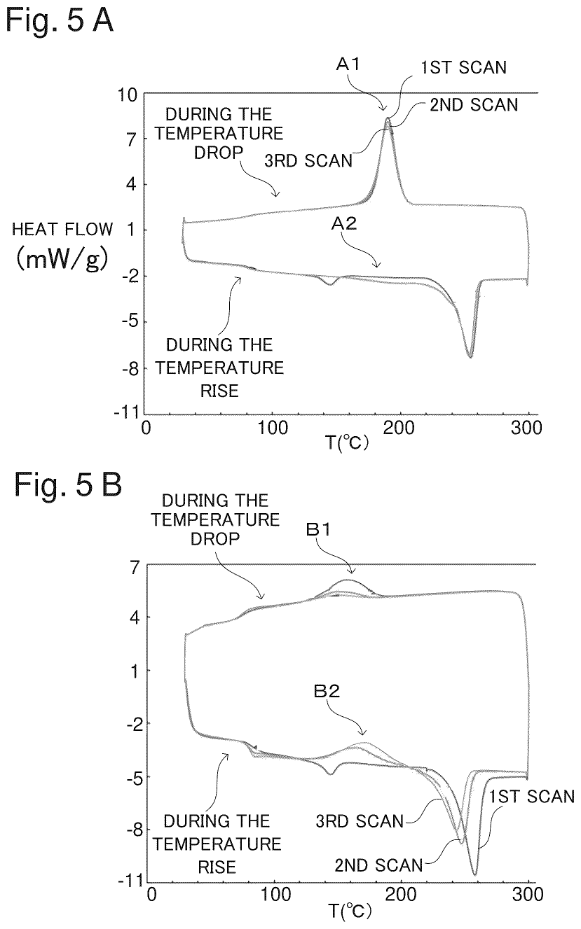

Referring now to FIG. 5A and FIG. 5B, measurement results provided by a differential scanning calorimeter (DSC), when the anti-crystallization agent is not added, and measurement results provided by a differential scanning calorimeter (DSC) when the anti-crystallization agent is added (according to the first embodiment) are compared with each other. FIG. 5A is a graph showing the measurement results provided by the differential scanning calorimeter, when an anti-crystallization agent is not added, and FIG. 5B is a graph showing the measurement results provided by the differential scanning calorimeter, when an anti-crystallization agent is added. The horizontal axis in FIG. 5A and FIG. 5B represents the temperature T (degrees Celsius), and the vertical axis represents the heat flow (mW/g). The measurement conditions of FIG. 5A and FIG. 5B are three cycles of temperature variation between 300 degrees Celsius and a room temperature, and the temperature rise/drop rate of 20 degrees Celsius per minute.

The differential scanning calorimeter is configured to measure the temperature of a reference substance and a specimen, while applying a prespecified heat, to acquire the temperature difference as the thermal property of the specimen, and measure the endothermic reaction and exothermic reaction arising from the status change of the specimen. The measurement of the thermal property by the differential scanning calorimeter enables perception of not only a simple status change due to heat, such as fusing, but also a phase transition of structure or crystallization, and is therefore broadly applied to property evaluation of polymer materials, organic materials, metals, ceramics, and so forth.

The measurement results provided by the differential scanning calorimeter, when the anti-crystallization agent is not added, indicate that, as shown in FIG. 5A, the peak of the heat flow (peak of crystallization) during the temperature drop is high (A1 in FIG. 5A), and that the peak of the heat flow (peak of crystallization) during the temperature rise is unable to be identified (A2 in FIG. 5A). Such a PET material is crystallized during the temperature drop in the injection molding process (during the cooling phase of the preform), in other words solidified rapidly (before the preform is expanded to a predetermined shape) during the blow molding process, and is therefore unsuitable for the injection blow molding.

On the other hand, the measurement results provided by the differential scanning calorimeter, when the anti-crystallization agent is added to the first pellet, indicate that, as shown in FIG. 5B, the peak of the heat flow (peak of crystallization) during the temperature drop is low (B1 in FIG. 5B), in other words the crystallization during the temperature drop is suppressed, and that the peak of the heat flow (peak of crystallization) during the temperature rise can be identified (B2 in FIG. 5B). In the case of such a PET material (second pellet used in the molding process of step S8), the crystallization is suppressed during the temperature drop in the injection molding process (during the cooling phase of the preform), and it takes a longer time before the preform is crystallized and solidified (the preform can be expanded to the predetermined shape before the PET material is solidified), in the blow molding process, compared with the case where the anti-crystallization agent is not added. Therefore, adding the anti-crystallization agent to the first pellet enables the injection blow molding process to be properly performed.

In addition, through the comparison between the case of FIG. 5A where the anti-crystallization agent is not added, and the case of FIG. 5B where the anti-crystallization agent is added, it can be understood that, by adding the anti-crystallization agent, the peak of the heat flow during the temperature drop is shifted to the lower side.

According to the first embodiment, adding the anti-crystallization agent to the first pellet, and processing the first pellet, to which the anti-crystallization agent has been added, into the second pellet to be formed into the resin molded article in the molding process of step S8, enables the crystallization of the PET (contained in the preform during the cooling phase thereof) to be suppressed, during the injection blow molding performed in the molding process of step S8, thereby prolonging the time before the PET is solidified during the blow molding, following the injection molding, compared with the case where the anti-crystallization agent is not added, and enabling the preform to be expanded to the predetermined shape. As result, the purpose of the reuse of the used PET film can be widened to the resin molded articles to be formed by injection blow molding.

### Second Embodiment

Hereafter, the reuse method of the used PET film according to a second embodiment of the disclosure will be described, with reference to the drawings. The reuse method of the used PET film according to a second embodiment is different from the first embodiment, in adding the anti-crystallization agent to the flake, instead of adding the anti-crystallization agent to the first pellet produced by processing the flake as in the first embodiment.

In the second embodiment, the used PET film with the ceramic stuck to the surface thereof is to be reused, as in the first embodiment. The PET film has, for example, an elongate shape, and contains at least the PET and the silicone resin. The content rate of the PET is, for example, 98%, and the content rate of the silicone resin is 2% or less. The used PET film refers to such PET film that has been used for the manufacturing of the layered electronic parts, and the residual ceramic is stuck to the surface of the used PET film.

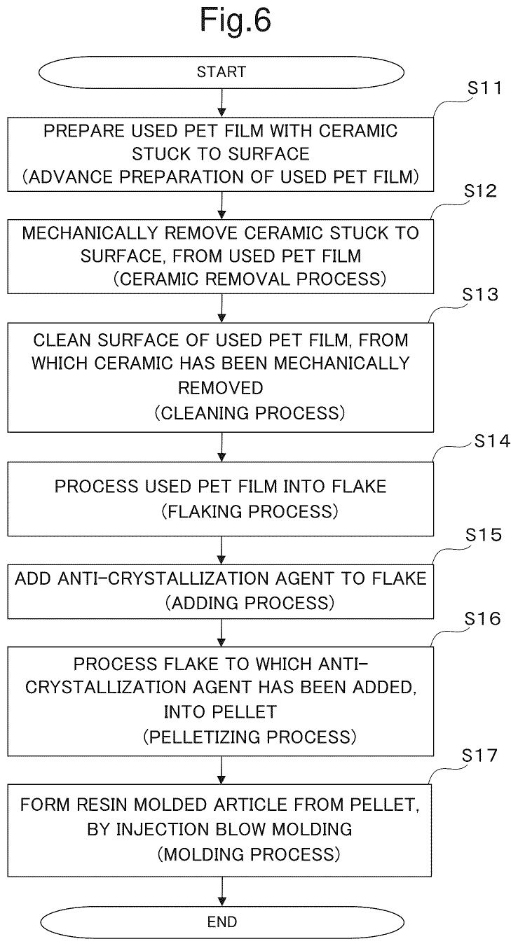

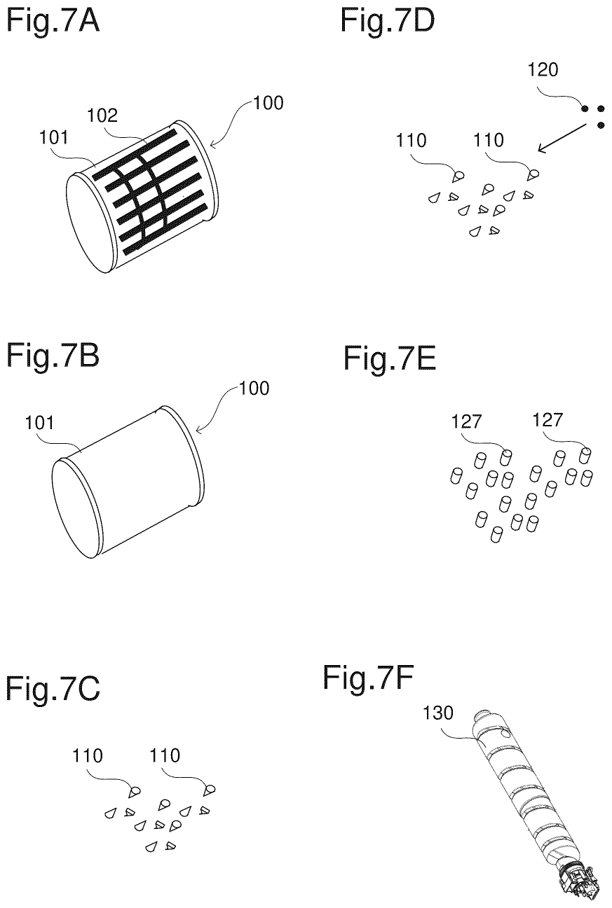

Hereunder, the steps of the reuse method of the used PET film with the ceramic stuck to the surface thereof will be described, with reference to FIG. 6, and FIG. 7A to FIG. 7F. FIG. 6 is a flowchart showing steps of the reuse method of the used PET film according to the second embodiment. FIG. 7A is a schematic perspective view showing an article involved in the reuse method of the used PET film specified in FIG. 6. FIG. 7B is a schematic perspective view showing another article involved in the reuse method of the used PET film specified in FIG. 6. FIG. 7C is a schematic drawing showing articles involved in the reuse method of the used PET film specified in FIG. 6. FIG. 7D is a schematic drawing showing other articles involved in the reuse method of the used PET film specified in FIG. 6. FIG. 7E is a schematic drawing showing other articles involved in the reuse method of the used PET film specified in FIG. 6. FIG. 7F is a schematic perspective view showing another article involved in the reuse method of the used PET film specified in FIG. 6.

First, the used PET film with the ceramic stuck to the surface thereof is prepared (step S11: advance preparation of used PET film). The used PET film contains at least the PET and the silicone resin. On the used PET film 100, prepared in the advance preparation of the used PET film of step S11, the ceramic 102 is stuck to the surface 101, as shown in FIG. 7A.

The ceramic 102 stuck to the surface 101 of the used PET film 100 is mechanically removed, from the used PET film 100 (step S12: ceramic removal process). In the ceramic removal process of step S12, a known method may be adopted, such as the method described with reference to the ceramic removal process (step S2) of the first embodiment. Through the ceramic removal process of step S12, the used PET film 100 with the ceramic 102 stuck to the surface 101, shown in FIG. 6A, is transformed to the used PET film 100 from which the ceramic 102 stuck to the surface 101 has been removed, as shown in FIG. 6B.

In the ceramic removal process (step S12), the ceramic stuck to the surface is mechanically removed, leaving the silicone resin contained in the used PET film unremoved. In other words, in the ceramic removal process (step S12), the silicone resin is left unremoved, when the ceramic stuck to the surface is mechanically removed. The surface 101 of the used PET film 100, from which the ceramic has been mechanically removed in the ceramic removal process (step S12), is cleaned (step S13: cleaning process), for example, by the same method as the cleaning process (step S3) of the first embodiment.

The used PET film 100, from which the ceramic 102 stuck to the surface 101 has been removed in the ceramic removal process (step S12), and the surface of which has been cleaned in the cleaning process (step S13) according to the second embodiment, is processed into the flake (step S14: flaking process). In the flaking process (step S14), a known method may be employed, such as the method described with reference to the flaking process (S4) of the first embodiment. Through the flaking process of step S14, the flake 110 shown in FIG. 6C is produced.

The anti-crystallization agent is added to the flake produced through the flaking process (step S14) (step S15: adding process). For example, the same anti-crystallization agent as that used for the first pellet, in the adding process (step S6) of the first embodiment, may be employed. In the adding process of step S15, the operator adds the additive 120 to the flake 110 as shown in FIG. 7D, and mixes them such that the flake 110 and the additive 120 are evenly dispersed.

The flake to which the additive has been added in the adding process (step S15) is processed into the pellet (step S16: pelletizing process). In the pelletizing process (step S16), a known method may be employed, such as the method described with reference to the first pelletizing process (step S5) of the first embodiment. Through the pelletizing process of step S16, the pellet 127 shown in FIG. 7E is produced.

The resin molded article is formed by injection blow molding, from the pellet produced in the pelletizing process (step S16) (step S17: molding process). Examples of the resin molded article formed by injection blow molding include a toner container bottle 130 of the image forming apparatus, having the appearance shown in FIG. 7F.

In the ceramic removal process (step S12), as described above, the ceramic stuck to the surface of the used PET film is mechanically removed, leaving the silicone resin contained in the used PET film unremoved. Accordingly, the resin molded article contains the silicone resin. Therefore, the resin molded article formed through the molding process (step S17) can be, for example, appropriately used as sliding parts, which may be the sliding parts of the image forming apparatus, or sliding parts of a product other than the image forming apparatus. Examples of the sliding parts of the image forming apparatus include the toner container bottle 130, which is required to have slidability, and includes gears that are required to be slidable.

Here, the resin molded article formed in the molding process (step S17) may be, for example, the sliding parts of the image forming apparatus, the sliding parts of a product other than the image forming apparatus, parts of the image forming apparatus other than the sliding parts, parts other than the sliding parts, of a product other than the image forming apparatus, a product required to have slidability, or a product not required to have slidability.

In the second embodiment also, the measurement results provided by the differential scanning calorimeter, when the anti-crystallization agent is added to the flake, are similar to the graph shown in FIG. 5B, and therefore adding the anti-crystallization agent to the flake enables the injection blow molding process to be properly performed.

According to the second embodiment, adding the anti-crystallization agent to the flake, and processing the flake to which the anti-crystallization agent has been added into the pellet to be formed into the resin molded article in the molding process of step S17, enables the crystallization of the PET (contained in the preform during the cooling phase thereof) to be suppressed, during the injection blow molding performed in the molding process of step S17, thereby prolonging the time before the PET is solidified during the blow molding, following the injection molding, compared with the case where the anti-crystallization agent is not added, and enabling the preform to be expanded to the predetermined shape. As result, the purpose of the reuse of the used PET film can be widened to the resin molded articles to be formed by injection blow molding.

Further, the pelletizing process according to the second embodiment only includes a single pelletizing process of step S16, and therefore the process from the ceramic removal process (step S12) to the molding process (step S17) can be performed through a fewer number of steps. As result, the manufacturing cost of the resin molded article can be reduced.

Examples of the existing reuse method of the used PET film include removing foreign substances stuck to the surface of the PET film with a cleaning liquid containing an organic solvent, and removing the cleaning liquid remaining on the surface of the PET film, thereby recycling the used PET film as a renewed PET film. In this case, however, the purpose of the reuse of the used PET film is limited to the utilization of the renewed PET film. In contrast, the arrangement according to the foregoing embodiments can widen the purpose of the reuse of the used PET film with the ceramic stuck to the surface thereof, to the resin molded articles to be formed by injection blow molding.

The disclosure may be modified in various manners, without limitation to the configuration according to the foregoing embodiments and the variations thereof. Further, the configurations and processes described in the first embodiment with reference to FIG. 1 to FIG. 5B, and in the second embodiment with reference to FIG. 6 to FIG. 7F, are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. A reuse method of a used PET film with a ceramic stuck to a surface thereof, the reuse method comprising:
a removal process including mechanically removing, from the used PET film, the ceramic stuck to the surface of the used PET film;
a flaking process including processing the used PET film, from which the ceramic stuck to the surface has been removed in the removal process, into a flake;
a first pelletizing process including processing the flake produced in the flaking process into a first pellet;
an adding process including adding an anti-crystallization agent to the first pellet, produced in the first pelletizing process;
a second pelletizing process including processing the first pellet, to which the anti-crystallization agent has been added in the adding process, into a second pellet; and
a molding process including forming a resin molded article through an injection blow molding process, from the second pellet produced in the second pelletizing process.

2. The reuse method of the used PET film according to claim 1,
wherein the used PET film contains at least PET and a silicone resin, and
in the ceramic removal process, the ceramic stuck to the surface is mechanically removed, leaving the silicone resin unremoved.

3. The reuse method of the used PET film according to claim 1, further comprising a cleaning process, performed between the removal process and the flaking process, and including cleaning the surface of the used PET film, from which the ceramic has been mechanically removed, in the removal process,
wherein the used PET film subjected to the flaking process is the used PET film, the surface of which has been cleaned.

4. The reuse method of the used PET film according to claim 3,
wherein the cleaning process includes using an organic solvent to clean the surface.

5. A reuse method of a used PET film with a ceramic stuck to a surface thereof, the reuse method comprising:
a removal process including mechanically removing, from the used PET film, the ceramic stuck to the surface of the used PET film;
a flaking process including processing the used PET film, from which the ceramic stuck to the surface has been removed in the removal process, into a flake;
an adding process including adding an anti-crystallization agent to the flake produced in the flaking process;
a pelletizing process including processing the flake, to which the anti-crystallization agent has been added in the adding process, into a pellet; and
a molding process including forming a resin molded article through an injection blow molding process, from the pellet produced in the pelletizing process.

6. The reuse method of the used PET film according to claim 5,
wherein the used PET film contains at least PET and a silicone resin, and
in the ceramic removal process, the ceramic stuck to the surface is mechanically removed, leaving the silicone resin unremoved.

7. The reuse method of the used PET film according to claim 5, further comprising a cleaning process, performed between the removal process and the flaking process, and including cleaning the surface of the used PET film, from which the ceramic has been mechanically removed, in the removal process,
wherein the used PET film subjected to the flaking process is the used PET film, the surface of which has been cleaned.

8. A pellet produced from a used PET film with a ceramic stuck to a surface thereof, through a process including:
mechanically removing, from the used PET film, the ceramic stuck to the surface of the used PET film;
processing the used PET film, from which the ceramic stuck to the surface has been removed, into a flake;
processing the flake into a first pellet;
adding an anti-crystallization agent to the first pellet, thereby setting an IV value of the pellet to a value within a predetermined range; and
producing the pellet by processing the first pellet to which the anti-crystallization agent has been added.

9. The pellet according to claim 8,
wherein the used PET film contains at least PET and a silicone resin, and
the silicone resin is left unremoved, when the ceramic stuck to the surface is mechanically removed.

10. The pellet according to claim 8,
wherein, after the ceramic stuck to the surface is mechanically removed, and before the used PET film in processed into the flake, the surface of the used PET film, from which the ceramic has been mechanically removed, is cleaned.

11. A pellet produced from a used PET film with a ceramic stuck to a surface thereof, through a process including:
mechanically removing, from the used PET film, the ceramic stuck to the surface of the used PET film;
processing the used PET film, from which the ceramic stuck to the surface has been removed, into a flake;
adding an anti-crystallization agent to the flake; and
producing the pellet by processing the flake to which the anti-crystallization agent has been added.

12. The pellet according to claim 11,
wherein the used PET film contains at least PET and a silicone resin, and
the silicone resin is left unremoved, when the ceramic stuck to the surface is mechanically removed.

13. The pellet according to claim 11,
wherein, after the ceramic stuck to the surface is mechanically removed, and before the used PET film in processed into the flake, the surface of the used PET film, from which the ceramic has been mechanically removed, is cleaned.

14. A resin molded article formed through an injection blow molding process, from the pellet according to claim 8.

15. The resin molded article according to claim 14,
wherein the used PET film contains at least PET and a silicone resin,
the silicone resin is left unremoved, when the ceramic stuck to the surface is mechanically removed, and
the resin molded article has slidability.

16. The resin molded article according to claim 15, to be incorporated in an image forming apparatus.
